(19) United States
(12) Patent Application Publication
(10) Pub. No.: US 2007/0008100 A1
(43) Pub. Date: Jan. 11, 2007

(54) Digital control and detection apparatus using pulse signal processing

(76) Inventors: Baohua Qi, Columbus, IN (US); Mi Yan, Columbus, IN (US)

Correspondence Address: Baohua Qi, 6076 Basswood Dr., Columbus, IN, 47201, US

(21) Appl. No.: 11/481,501

(22) Filed: Jul. 6, 2006

Related U.S. Application Data
(60) Provisional application No. 60/697,196, filed on Jul. 7, 2005.

(51) Int. Cl. G08B 29/00

(52) U.S. Cl. 340/506

(57) ABSTRACT

A solid-state digital control and detection apparatus employs electronic sensors to create pulse signals, the width of which is determined by sensing values. The sensing pulses are then compared with setting pulses, the width of which is adjustable, in two types of comparison circuits. Result pulses from one of the comparison circuits are filtered for control and that from the other one are digitalized for display by using counters.

This present application claims priority from U.S. provisional application No. 60/697,196 having the same tile as the present invention and filed on Jul. 7, 2005.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

This invention relates to apparatus for acquiring from sensors the electric signals that are determined by the physical or chemical properties of an object, displaying the signal values, processing the signals, and creating control signals for actuation of responsive devices for controlling these properties of the object to predetermined desired values.

### BACKGROUND OF THE INVENTION

Sensors are used to convert the physical or chemical properties of an object to electrical signals such as voltage and current. A modern digital sensing apparatus normally comprises of sensors, a signal-processing unit that applies stimulus signals to the sensors if necessary, and amplifies, filters the signals acquired from the sensors, an Analog to Digital (A/D) device that converts the analog signals to digital signals, and a communication unit that receives inquiry commands and sends out sensing data to a computer.

Basically, an A/D device is used to compare the input voltage to a reference voltage to convert voltage level signals to digital signals. To obtain an accurate result, a high precision and stable reference voltage source is needed, and the input voltage change in sampling should be minimized. As a result, for passive sensors that do not generate electrical signals, e.g. resistive sensors and capacitive sensors, a dedicated voltage or current stimulus source is required, and sometimes a complex signal stimulus and signal processing circuit should be implemented. For example, for capacitive sensors, usually a square wave or sine wave generator is used to provide the alternate current stimulus, and the output signals are rectified to generate a low frequency signal, the level of which changes with the sensor capacitance.

In this invention, a sensor interface circuit, which converts the sensing values directly to digital signals without using A/D devices, is presented. In the presented sensor interface circuit, pulse width, which is determined by the sensing values, rather than voltage level is used for digital signal conversion. Since no voltage level signals are employed for comparison and reference, the circuits are insensitive to the change or fluctuation of voltage supply. For example, if CMOS devices are used, the circuit can work in a voltage range of 3V to 18V. Based on that, a controller can be constructed either by using the digital sensing values or by directly comparing the sensing pulse with a value setting pulse.

It is an object of the present invention to provide digital sensing, control, and communication circuits that are not sensitive to changes or fluctuation of voltage supplies.

A second object is to provide a sensor interface circuit that needs not a dedicated conditioning circuit converting the signals from the sensor to appropriate signals for the A/D device; therefore, the circuit is simplified.

Another object is to provide a compact digital sensing and control circuit that is able to work without employing microcontrollers or microcomputers. Thus, products based on the circuits can re-use small-scale logic devices from old computers to reduce pollution to environment.

### BRIEF SUMMARY OF THE INVENTION

The apparatus of the present invention, for signal acquirement, display, communication, and control, comprises electronic means for sensing the properties of an object, means for creating electronic signals relating to the measure of the sensed properties within a sensitivity range, electronic means for processing the signals for display, electronic means for displaying the signal values, electronic means for receiving commands from a computer or an analog controller, and sending signal values to a computer, electronic means for processing the signals acquired from the sensors to create therefrom control signals for actuation of responsive devices to control the properties of the object to predetermined desired values.

To acquire signals from sensors, in the present invention, pulse width comparison, which includes a sensing pulse, the width of which changes with the sensing values, and a setting pulse, the width of which is adjustable by using either digital means (e.g. counters) or analog means (e.g. resistors or capacitors), is used. The means for sensing pulse generation uses mono-stable multi-vibrator, while either the digital pulse generation that includes an oscillator and a counter, or the mono-stable multi-vibrator can be used for setting pulse generation.

Two types of pulse comparison are presented. One is used for control. Signals generated by the pulse comparison pass through a time-delay circuit, which is employed to prevent rapid on/off cycling, and the result control signals are then used to control the responsive device. The other type of pulse comparison is for digitalization. Signals through the pulse comparison are converted to digital signals by using a counter, and a low pass digital filter is used to decrease the effects of high frequency noise. The result digital signals are then sent to a display or a digital controller.

The circuits described in the present invention can be integrated into a dedicated IC for sensor interface and control. Since no A/D is needed, and no complex computation is necessary, the IC can be low-cost. On the other hand, all the circuits in the present invention can also be realized by using small-scale logic devices such as 74HC series, 4000 series. Thus, products based on the circuits described in this invention can reuse small-scale logic devices from old computers to reduce pollution to environment.

Other features and advantages of the invention will be apparent from the following description, including accompany drawings, of illustrative embodiments thereof.

### BIREF DESCRIPTION OF THE DRAWINGS

FIG. 1 is a block diagram schematically showing the relation of the functional circuit sections (including control, display and communication) in the present invention;

FIG. 2 is a schematic diagram of a humidity controller embodying the present invention;

FIG. 3 is a timing diagram of the apparatus in FIG. 2;

FIG. 4 shows the waveform of the time-delay circuit in FIG. 2;

FIG. 5 is a schematic diagram of a display and communication circuit embodying the present invention;

FIG. 6 is a timing diagram of the apparatus in FIG. 5.

### DETAILED DESCRIPTION OF THE INVENTION

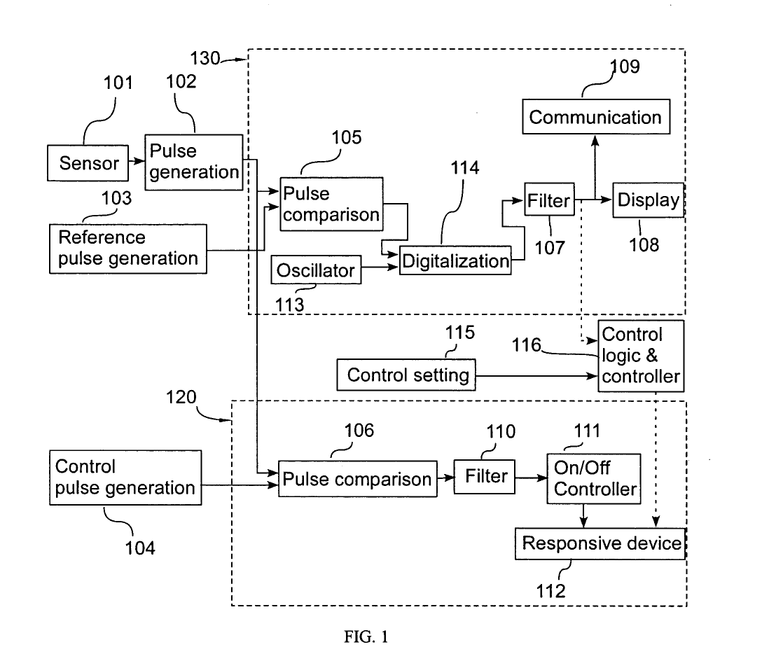

The present invention includes three functions: control, display, and communication. Referring to FIG. 1, a sensor 101 is connected to a pulse generation circuit 102 that is used to generate a pulse, the width of which changes with sensing values. In the display and communication block 130, this sensing pulse is compared with a pulse generated by the reference pulse generation circuit 103 in a pulse comparison unit 105, and therein the pulse width is adjusted according to the sensing range. The output pulse from the unit 105 is then digitalized in a circuit 114 by using an oscillator 113 and filtered through a circuit 107. The result digital signals are displayed through a device 108. Either the pulse signals generated by the pulse comparison circuit 105 or digital signals from the filter 107 can be sent to a circuit 109 for communication.

In a control block 120, a control pulse is generated by a circuit 104, and compared with the sensing pulse from the circuit 102 in a pulse comparison unit 106. The result pulse from the unit 106 is then filtered through a circuit 110, and used to control an on/off controller 111, which is employed to control a responsive device 112. In addition to the control pulses from the filter 110, the response device 112 can also be controlled by the signals generated by a control circuit 116 based on the control setting input from a circuit 115 and the digital sensing signals from the filter 107.

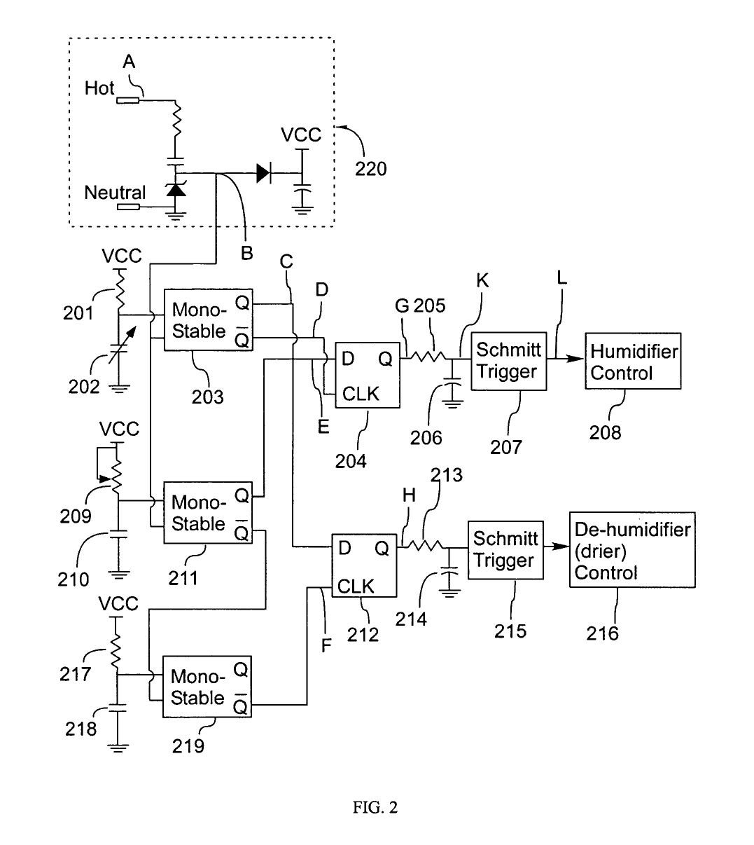

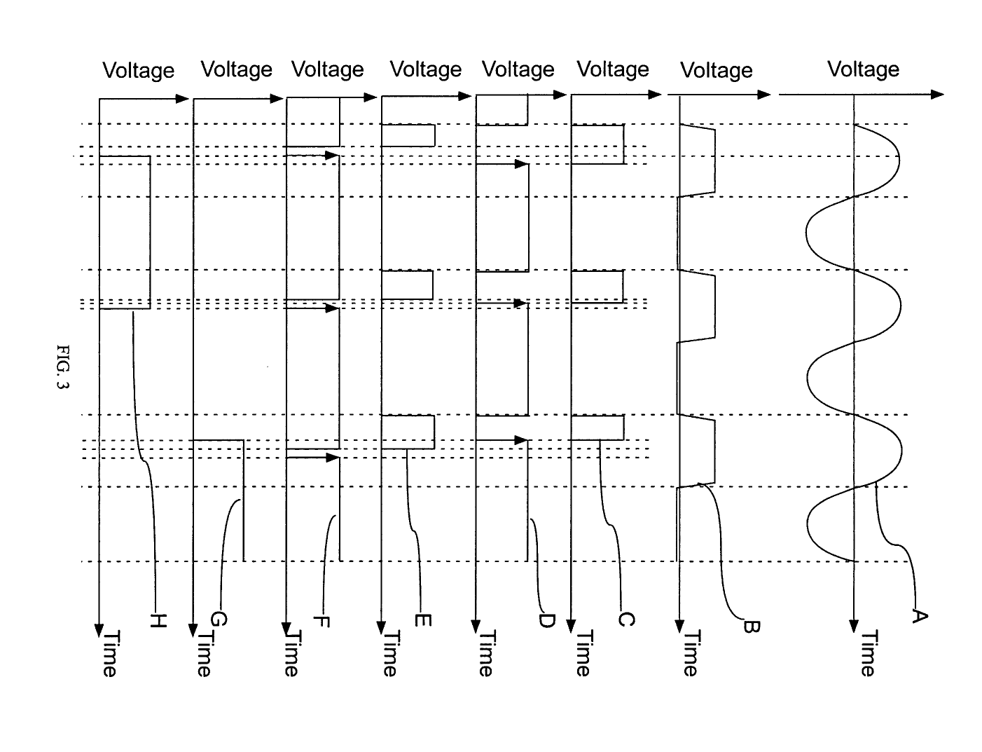

An example of the controller 120 depicted in FIG. 1 is a relative humidity controller illustrated in FIG. 2. Since the pulse processing is insensitive to power supply, a simple AC/DC converter circuit 220 is used to provide a DC voltage VCC for the controller and a synchronous pulse for the sensor pulse generation and reference pulse generation. The waveforms at points A and B are shown in FIG. 3. Alternate sinusoidal wave from the power line (point A) is converted to synchronous pulses, the amplitude of which is determined by the zener voltage of the zener diode in the converter 220.

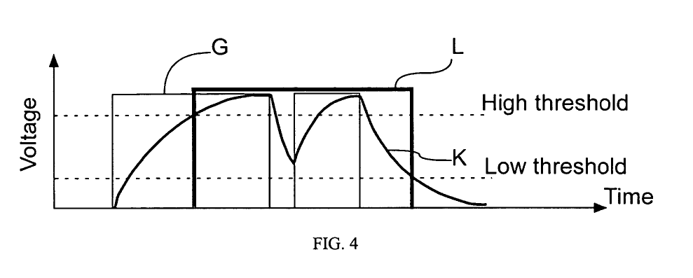

The sensor for this controller can be either a resistive sensor or a capacitive sensor. If a capacitive sensor 202 is used, then a resistor 201 will be used with the sensor to generate a pulse (the width of which changes with the sensing values) through a mono-stable multi-vibrator 203. The reference pulse is generated by a mono-stable multi-vibrator 211, and the pulse width is set by using a capacitor 210 and a potentiometer 209. Pulse D and E from the mono-stable multi-vibrators are compared in a D-type flip-flop 204. If a positive coefficient sensor is used, then when the width of pulse D is shorter than pulse E, the environmental humidity is lower than the setting value. As shown in FIG. 3, in this situation, through the D-type flip-flop 204, a high level signal will be generated at point G, which is used to turn on a humidifier through a RC low-pass filter including a resistor 205 and a capacitor 206, a Schmitt trigger 207, and an on/off humidifier control circuit 208. The waveforms at G and two ends of the Schmitt trigger, K and L, are depicted in FIG. 4. The high level signal at G charges the capacitor 206 through the resistor 205. A high level “on” signal is not generated at L until the voltage at K is higher than the high threshold of the Schmitt trigger 207. When the environmental humidity is higher than the setting value, a low level signal appears at G. If the low level signal persists longer than the time set by the resistor 205 and the capacitor 206, then the humidifier will be turned off. When the humidity hovers at the setting value, short pulses may appear at G. The humidifier can only be turned on when the charge accumulated in the capacitor 206 is enough to make the voltage at K higher than the high threshold of the Schimitt trigger 207, and be turned off when voltage at K is lower than the low threshold. Accordingly, by using this method, quick on/off is avoided by setting the minimum on/off time using the resistor 205 and the capacitor 206.

If only a humidifier or de-humidifier is used, then by using the low-pass filter and the Schmitt trigger, quick on/off can be avoided without setting a humidity hysteresis, i.e. the humidifier or de-humidifier is turned on and off at the same humidity, thus, the humidity can be controlled accurately at a value. However, if both a humidifier and a de-humidifier are used simultaneously, then to prevent the two devices working at the same time, a humidity hysteresis is needed. The hysteresis in FIG. 2. is realized by using an mono-stable multi-vibrator 219, with a resistor 217 and a capacitor 218 setting an extra pulse, the width of which is longer than the minimum off time of the humidifier control set by the resistor 205 and the capacitor 206. The extra pulse and the reference pulse from the mono-stable multi-vibrator 211 are then compared in a D-type flip-flop 212. As shown in FIG. 3, the result control signal level at H will not be high until the humidity sensing pulse at C is longer than that of the reference pulse plus the extra pulse. The D-type flip-flop 212 is followed by a time-delay circuit including a resistor 213, a capacitor 214, and a Schmitt-trigger 215. And the filtered control signal from the Schmitt trigger 215 is sent to a circuit 216 for dehumidifier control.

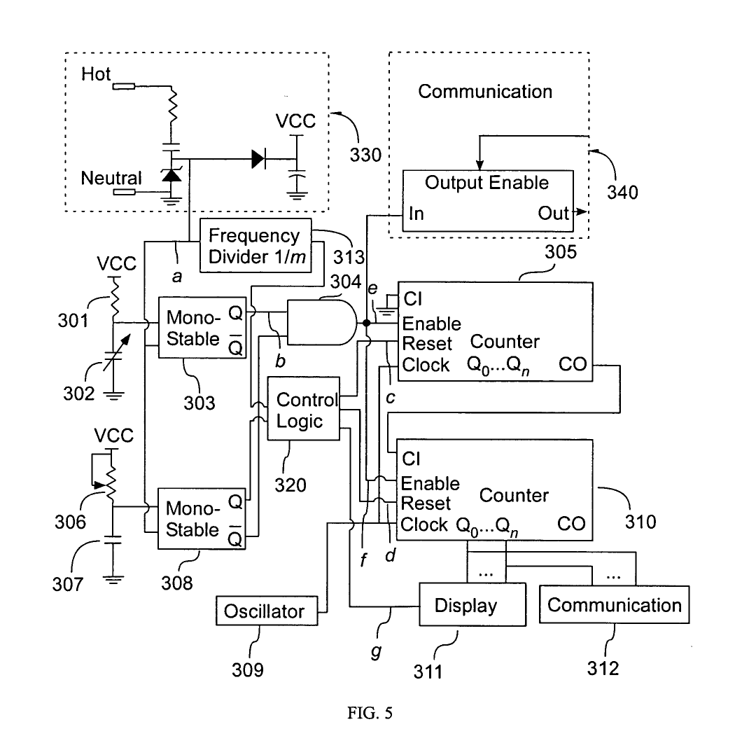

An example embodying the display and communication block 130 depicted in FIG. 1 is shown in FIG. 5. This circuit can be used to filter and display the values acquired from a capacitive sensor. Due to the pulse processing nature, this circuit is insensitive to the voltage supply. Therefore, a simple AC/DC converter 330 is used. The converter 330 provides power supply and synchronous pulses for the circuit. A capacitive sensor 302 and a resistor 301 are connected to a mono-stable multi-vibrator 303, and used to set the pulse width that changes with the sensing value. The sensing pulse is then compared with a setting pulse that is generated by using a capacitor 307, a resistor 306, and a mono-stable multi-vibrator 308 in an AND gate 304. The pulse comparison is used to zeroize the reading.

The AND gate 304 is connected to the counters, the clock of which is provided by an oscillator 309, and the reset logic is controlled by a control logic circuit 320. Synchronous pulses of the circuit 320 are provided by the AC/DC converter 330 through a frequency divider 313, where the frequency of the synchronous pulses is divided by a number m. As an example of the counter circuit, two counters, 305 and 310 are drawn in FIG. 5. The carry output (CO) of the counter 305 is connected to the carry input (CI) of the counter 310. Thus, Q0 of the counter 305 is the least significant bit, while Qn of the counter 310 is the most significant bit, provided that Q0 is the least significant bit of the counters. The outputs Q0 to Qn of the counter 310 are connected to a display circuit, the logic of which is also controlled by the control logic circuit 320. When binary counters are used, in the counter circuit, the frequency of the oscillator should be ƒ,
ƒ=2^{kn}/(mT),

where T is the sensing pulse width corresponding to the full scale of the sensor, and k is the number of counters (k=2 in this example). If BCD (Binary Coded Decimal) counters are used, then
ƒ=10^{kn/4}/(mT).

For example, if the counters 305 and 310 are two 2-decade BCD counters (n=8), and a 2-decade BCD counter is used for the frequency divider 313 (m=100), the frequency of the oscillator then should be 100/T. If a capacitive relative humidity sensor is used as the sensor 302, and the capacitances corresponding to 100% and 0 are, respectively, Cₘₐₓ and Cₘᵢₙ, then the frequency of the oscillator 309 is 100/[g(RCₘₐₓ)−g(RCₘᵢₙ)], where R is the resistance of the resistor 301, and g(RC) is a function determined by the mono-stable multi-vibrators (e.g. for 74HC221, g(RC)=0.7 RC). In this example, if the counters 305 and 310 are reset and enabled with high level, then the control logic in the circuit 320 can be:

313Pulse99=313Q0 AND 313Q3 AND 313Q4 AND 313Q7,

313Pulse98=(NOT 313Q0) AND 313Q3 AND 313Q4 AND 313Q7,

305Reset=310Reset=313Pulse99 AND 308Q,

305Enable=310Enable=303Q AND 308 Q̅,

DisplayLatch=313Q98 AND 303Q,

where 313Q0, 313Q1, . . . , 313Q7 are, respectively, the ouput bit0 to bit7 (not shown in the figure) of the divider 313; 303Q is the sensing pulse output b of the mono-stable multi-vibrator 303; 308Q and 308 Q̅ are the setting pulse outputs of the mono-stable multi-vibrator 308; 305Reset and 306Reset are the Reset inputs of the counters 305 and 310, while 305Enable and 310Enable are the Enable inputs which enable the counting; DisplayLatch is a control signal line that can be used to latch the digital output signals into the display register. In this example, a falling edge signal is provided for the DisplayLatch. (A rising edge signal can be obtained through an inverter.)

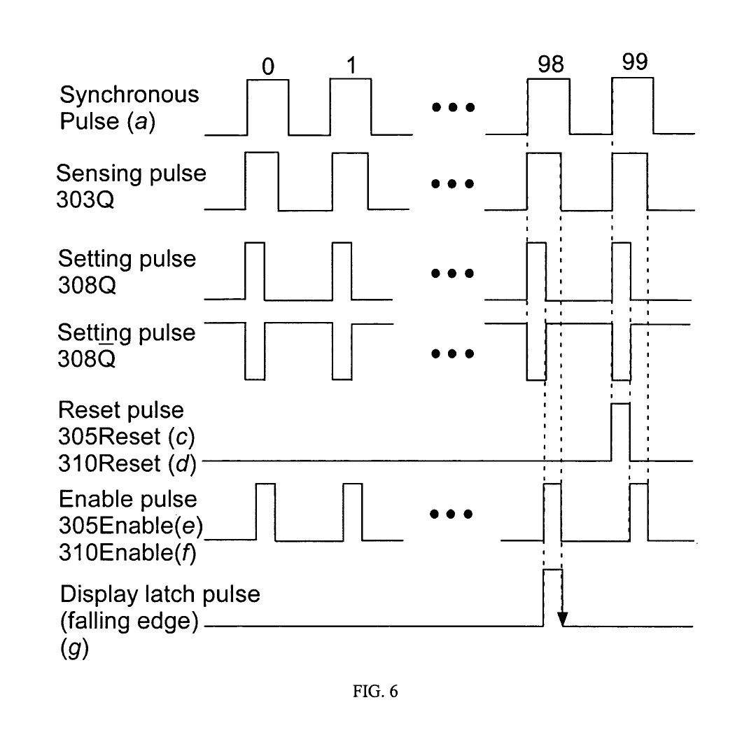

The timing diagram of this circuit example is illustrated in FIG. 6. The setting pulse at 308Q is synchronized by the pulses output from the frequency divider 313. At pulse 99, 313Pulse99 is 1 (high level). With the rising of the 313Q pulse, the counters 305 and 306 are reset to 0 when the reset pulse appears on 305Reset and 310Reset. At the falling edge of the reset pulse, the counters 305 and 310 are enabled by the adjusted sensing pulse (Enable pulse), the pulse width of which is the difference between the sensing pulse and the setting pulse. The counters 305 and 310 accumulate the counts for the width of adjusted sensing pulses, and a display latch pulse is generated at synchronous pulse 98. The falling edge of this display latch pulse is used to latch the output of the counter 310 to the register of a display (not shown in the figure). Since the counting for the width of adjusted sensing pulses starts at the synchronous pulse 99, the width of 100 adjusted sensing pulses will be accumulated in the counters before reset. The frequency of the oscillator is selected to be 100/T, therefore, at each adjusted sensing pulse i, the count in the counters 305 and 310 will increase 100Tᵢ/T, where Tᵢ is the pulse width. At the synchronous pulse 99, the output of the counters 305 and 310 before reset is

$${\sum }_{i = 1}^{100} 100 {T}_{i} / T .$$

Connecting only the counter 310 to a display 311, then the display value is the output of the counter 310,

$$\frac{{\sum }_{i = 1}^{100} 100 {T}_{i} / T}{100}$$

, which is the average pulse width of 100 pulses in a resolution of two digits, thereby, a filter is implemented. The filter is able to remove high frequency disturbance, and is important to steady reading of sensor values.

Both of the adjusted sensing pulse (e) and the digital signals for the display 311 can be used for communication. For the adjusted sensing pulse (e), a simple communication circuit 340 is used. In this circuit, the command is the Output Enable, the high level (or low level) enables the pulse signals to appear at the Out port. A communication circuit 312 is connected to the digital signals for the display 311. Either a serial communication or a parallel communication can be employed.

In summary, in the present invention, the pulse signals, the width of which is determined by the sensing values, are digitalized for display and used for control without A/D conversion. The circuits based on this invention are simple and insensitive to the supply voltage. In addition to being integrated into an IC, the circuits can also be realized by using small-scale logic devices such as 74HC series, 4000 series. Thus, products based on the circuits described in this invention can reuse small-scale logic devices from old computers to reduce pollution to environment.

1. An apparatus for producing a control signal for actuation of a responsive device for changing a condition to a predetermined desired condition, said apparatus comprising
(a) electronic means for sensing the condition;
(b) means for creating pulse signals, the width of which is determined by the measure of said condition being sensed by said electronic means within a sensitivity range and pulse signals, the width of which is determined by a setting means, synchronized by a pulse signal;
(c) electronic means for processing said sensing pulse signals to create control signals by comparison the width of said sensing pulse signals and the width of the said setting signals at each cycle of said synchronous signal;
(d) electronic means for filtering said control signals;

2. An apparatus as in claim 1, in which said sensing means (a) has electrical impedance varying in the measure of said condition.

3. An apparatus as in claim 1, in which said sensing pulses and said setting pulses in said means (b) are generated by mono-stable multi-vibrators.

4. An apparatus as in claim 1, in which said synchronous pulses in said means (b) are provided by an alternate power source.

5. An apparatus as in claim 1, in which said pulse comparison is achieved by latching one pulse using another.

6. An apparatus according to claim 5 wherein a flip-flop is used for said pulse latching.

7. An apparatus as in claim 1, in which said means (d) provides a minimum on and off time for the actuation of said responsive device.

8. An apparatus according to claim 7 wherein said minimum on and off time is set by using a low pass filter and a Schmitt trigger.

9. An apparatus for display signals acquired from a sensing means that is employed to change the physical or chemical properties of an object into electronic signals, said apparatus comprising
(a) electronic means for sensing the properties of an object;
(b) means for creating pulse signals, the width of which is determined by the measure of said condition being sensed by said electronic means within a sensitivity range and pulse signals, the width of which is determined by a setting means, synchronized by a pulse signal;
(c) electronic means for processing said sensing pulse signals to create adjusted sensing signals by comparing the width of said sensing pulse signals and the width of said setting signals at each cycle of said synchronous signal;
(d) electronic means for digitalizing said adjusted sensing signals;
(e) electronic means for filtering said digitalized sensing signals;
(f) electronic means for displaying said filtered digital signals.

10. An apparatus as in claim 9, in which said sensing means (a) has electrical impedance varying in the measure of said condition.

11. An apparatus as in claim 9, in which said sensing pulses and said setting pulses in said means (b) are generated by mono-stable multi-vibrators.

12. An apparatus as in claim 9, in which said synchronous pulses in said means (b) are provided by an alternate power source.

13. An apparatus as in claim 9, in which said pulse comparison in said means (c) is achieved by using an AND gate.

14. An apparatus as in claim 9, in which said digitalization means (d) comprises a counter enabled by said adjusted sensing pulses, and a clock for said counter.

15. An apparatus according to claim 9 and claim 14, wherein said filtering means (e) is realized by allowing only high digits of said counter pass.

16. An apparatus for producing a control signal for actuation of a responsive device for changing a condition to a predetermined desired condition, said apparatus comprising
(a) electronic means for sensing the condition;
(b) means for creating pulse signals, the width of which is determined by the measure of said condition being sensed by said electronic means within a sensitivity range and pulse signals, the width of which is determined by a setting means, synchronized by a pulse signal;
(c) electronic means for processing said sensing pulse signals to create adjusted sensing signals by comparison the width of said sensing pulse signals and the width of the said setting signals at each cycle of said synchronous signal;
(d) electronic means for digitalizing said adjusted sensing signals;
(e) electronic means for filtering said digitalized sensing signals;
(f) electronic means for using said digitalized sensing signals to control the actuation of said responsive device.

17. An apparatus as in claim 16, in which said sensing means (a) has electrical impedance varying in the measure of said condition.

18. An apparatus as in claim 16, in which said sensing pulses and said setting pulses in said means (b) are generated by mono-stable multi-vibrators.

19. An apparatus as in claim 16, in which said digitalization means (d) comprises a counter enabled by said adjusted sensing pulses, and a clock for said counter.

20. An apparatus according to claim 16 and claim 19, wherein said filtering means (e) is realized by allowing only high digits of said counter pass.
